(19) United States
(12) Patent Application Publication
(10) Pub. No.: US 2026/0074762 A1
(43) Pub. Date: Mar. 12, 2026

(54) METHODS AND APPARATUSES FOR TRANSMITTING AND RECEIVING CHANNEL STATE INFORMATION AND COMMUNICATION SYSTEM

(71) Applicant: FUJITSU LIMITED, Kawasaki-shi (JP)

(72) Inventors: Qun ZHANG, Beijing (CN); Xin WANG, Beijing (CN)

(73) Assignee: FUJITSU LIMITED, Kawasaki-shi (JP)

(21) Appl. No.: 19/386,750

(22) Filed: Nov. 12, 2025

Related U.S. Application Data
(63) Continuation of application No. PCT/CN2023/094223, filed on May 15, 2023.

(51) Int. Cl. H04B 7/06

(52) U.S. Cl. CPC H04B 7/0626; H04B 7/0639

(57) ABSTRACT

An apparatus for transmitting channel state information, applicable to a terminal equipment, includes first processor circuitry, wherein the terminal equipment, by the first processor circuitry controlling the terminal equipment, is configured to: receive, by the terminal equipment, first configuration information transmitted by a network device, at least a part of the first configuration information being information of a bitwidth of second information; and transmit channel state information at least based on the information of the bitwidth.

### CROSS-REFERENCE TO RELATED APPLICATION

This application is a continuation application under 35 U.S.C. 111(a) of International Patent Application PCT/CN2023/094223 filed on May 15, 2023, and designated the U.S., the entire contents of which are incorporated herein by reference.

### TECHNICAL FIELD

This disclosure relates to the field of communication technologies.

### BACKGROUND

Multiple-input multiple-output (MIMO) technology is one of the key technologies for 5G mobile communication. MIMO is able to provide higher channel capacity, but the realization of the benefit depends on whether accurate channel state information may be acquired.

In the MIMO technology, a terminal equipment measures spatial channels and feeds channel state information (CSI) back to a network device. According to the channel state information reported by the terminal equipment, the network device may select an appropriate precoding matrix suitable for the terminal equipment in performing downlink transmission, thereby reducing a probability of receiving bit errors of the terminal equipment as much as possible.

A channel state information generation and feedback process may be summarized as follows. The network device transmits channel state information reference signals (CSI-RSs) to terminal equipments, and the terminal equipments estimate channels based on the received CSI-RSs to obtain estimation of a spatial channel matrix. The terminal equipments further utilize the estimated spatial channels to obtain CSI. In the New Radio (NR) technology, a feedback mode of CSI is implicit feedback, that is, the terminal equipments provide CSI in a form of recommending transmission parameters to the network device, the transmission parameters including a channel state information reference signal resource indicator (CQI), a precoding matrix indicator (PMI), a CSI-RS resource indicator (CRI), a synchronization signal block resource indicator (SSBRI), a layer indicator (LI), a rank indicator (RI), and physical layer RSRP (L1-RSRP), etc. A base station may directly use the parameters recommended by the terminal equipment to perform downlink transmission, or, it may not use the recommended parameters.

In a frequency division duplex (FDD) system, for a downlink, when the network device uses information of downlink channels for precoding, the terminal equipment is needed to feed back the downlink channel state information to the network device via an uplink. However, as the information of downlink channels is proportional to the number of antennas of the network device, in a scenario of massive MIMO, the huge number of antennas of the network device will lead to a very large amount of feedback on the channel state information of the downlink channels. Enhanced codebooks (such as eType II codebooks) for downlink feedback has been designed in the Third Generation Partnership Project (3GPP), in which feedback amount of channel state information is reduced through frequency domain compression. However, for valuable uplink resources, there is still a need to further reduce the amount of uplink feedback.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

With the development of artificial intelligence/machine learning (AI/ML) technologies, applying the AI/ML technologies to physical layers of wireless communication to solve difficulties in related methods has become a current technological direction.

FIG. 1 is a schematic diagram of CSI feedback based on AI/ML. An AI/ML module may include an AI/ML-based CSI generation portion and an AI/ML-based CSI reconstruction portion, wherein the AI/ML-based CSI generation portion includes an AI/ML model, the AI/ML model including an AI/ML encoder and a quantizer. In addition, and further including a preprocessing module. The AI/ML-based CSI reconstruction portion includes an AI/ML reconstruction model, the AI/ML reconstruction model including a dequantizer and an AI/ML decoder, and further including a post-processing module.

As shown in FIG. 1, in operation 101, the terminal equipment side performs processing by using the AI/ML-based CSI generation portion to obtain CSI, and the network device receives the CSI via air interface; and in operation 102, the network device performs processing on the received CSI by using the AI/ML-based CSI reconstruction portion to obtain recovered CSI.

It was found by the inventors that in the related art, the CSI reporting configuration only supports CSI generated based on codebooks. However, how to configure relevant information of bitwidths of CSI generated based on an AI/ML method is not found in the related art.

In order to solve at least one of the above problems or other similar problems, embodiments of this disclosure provide methods and apparatuses for receiving and transmitting channel state information and a communication system. In the method, first configuration information transmitted by the network device to the terminal equipment contains relevant information of bitwidths of CSI, hence, relevant information of bitwidths of CSI may be configured for the terminal equipment.

According to one aspect of the embodiments of this disclosure, there is provided an apparatus for transmitting channel state information, applicable to a terminal equipment, the apparatus including a first processing unit, the first processing unit controlling the terminal equipment to make the terminal equipment execute the following operations:
receiving, by the terminal equipment, first configuration information transmitted by a network device, at least a part of the first configuration information being information of a bitwidth of second information; and
transmitting channel state information at least based on the information of the bitwidth.

According to another aspect of the embodiments of this disclosure, there is provided an apparatus for receiving channel state information, applicable to a network device, the apparatus including a second processing unit, the second processing unit controlling the network device to make the network device execute the following operations:
transmitting first configuration information by the network device to a terminal equipment, at least a part of the first configuration information being information of a bitwidth of second information; and
receiving channel state information at least based on the information of the bitwidth.

An advantage of the embodiments of this disclosure exists in that in the method, the first configuration information transmitted by the network device to the terminal equipment contains relevant information of bitwidths of CSI, hence, relevant information of bitwidths of CSI may be configured for the terminal equipment.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in more than one additional drawing or embodiment. Moreover, in the drawings, like reference numerals designate corresponding parts throughout the several views and may be used to designate like or similar parts in more than one embodiment.

FIG. 1 is schematic diagram of performing CSI feedback based on AI/ML;

FIG. 2 is a schematic diagram of a communication system of this disclosure;

FIG. 3 is a schematic diagram of a method for transmitting channel state information (CSI) of embodiments of a first aspect of this disclosure;

FIG. 4 is a schematic diagram of a method for receiving channel state information (CSI) of a embodiments of a second aspect of this disclosure;

FIG. 5 is a schematic diagram of an apparatus for transmitting channel state information (CSI) of embodiments of a third aspect of this disclosure;

FIG. 6 is a schematic diagram of an apparatus for receiving channel state information (CSI) of embodiments of fourth aspect of this disclosure;

FIG. 7 is a schematic diagram of a terminal equipment of a fifth aspect of this disclosure; and

FIG. 8 is a schematic diagram of a network device of the fifth aspect of this disclosure.

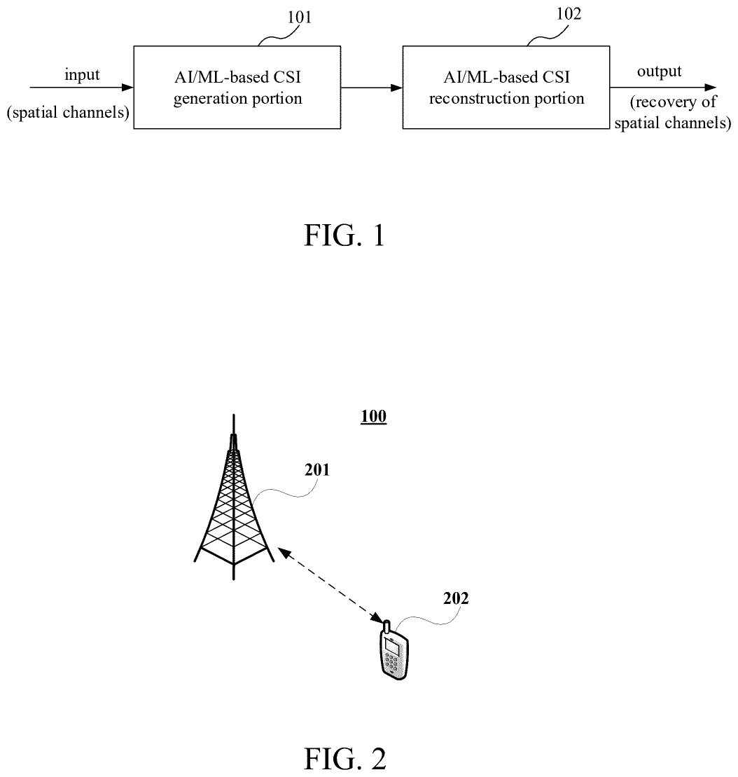

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of more than one relevantly listed terms. Terms “contain”, “include” and “have” refer to existence of stated features, elements, components, or assemblies, but do not exclude existence or addition of more than one other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, 5G, and new radio (NR), etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: an integrated access and feedback node (IAB-node), a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” or “terminal equipment (TE) or terminal device” refers to, for example, an equipment accessing to a communication network and receiving network services via a network device. The user equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the terminal equipment may also be a machine or a device performing monitoring or measurement. For example, it may include but not limited to a machine-type communication (MTC) terminal, a vehicle mounted communication terminal, an industrial wireless device, a surveillance camera, a device to device (D2D) terminal, and a machine to machine (M2M) terminal, etc.

Moreover, the term “network side” or “network device side” refers to a side of a network, which may be a base station or more than one network devices including those described above. The term “user side” or “terminal side” or “terminal equipment side” refers to a side of a user or a terminal, which may be a UE, and may include more than one terminal equipments described above.

In the following description, without causing confusion, the terms “uplink control signal” and “uplink control information (UCI)” or “physical uplink control channel (PUCCH)” may be replaced mutually, and terms “uplink data signal” and “uplink data information” or “physical uplink shared channel (PUSCH)” may be replaced mutually.

The terms “downlink control signal” and “downlink control information (DCI)” or “physical downlink control channel (PDCCH)” may be replaced mutually, and the terms “downlink data signal” and “downlink data information” or “physical downlink shared channel (PDSCH)” may be replaced mutually.

In addition, transmitting or receiving a PUSCH may be understood as transmitting or receiving uplink data carried by the PUSCH, transmitting or receiving a PUCCH may be understood as transmitting or receiving uplink information carried by the PUCCH, transmitting or receiving a PRACH may be understood as transmitting or receiving a preamble carried by the PRACH. The uplink signal may include an uplink data signal and/or an uplink control signal, etc., and may be referred to as uplink transmission or uplink information or an uplink channel. Transmitting uplink transmission on an uplink resource may be understood as transmitting the uplink transmission by using the uplink resource. Likewise, downlink data/signal/channel/information may be understood correspondingly.

In the embodiments of this disclosure, high-layer signaling may be, for example, radio resource control (RRC) signaling; for example, it is referred to an RRC message, which includes an MIB, system information, and a dedicated RRC message; or, it is referred to an as an RRC information element (RRC IE). High-layer signaling may also be, for example, medium access control (MAC) signaling, or an MAC control element (MAC CE); however, this disclosure is not limited thereto.

Scenarios in the embodiments of this disclosure shall be described below by way of examples; however, this disclosure is not limited thereto.

FIG. 2 is a schematic diagram of a communication system of this disclosure, in which a case where a terminal equipment and a network device are taken as examples is schematically shown. As shown in FIG. 2, the communication system 100 may include a network device 201 and a terminal equipment 202 (for the sake of simplicity, an example having only one terminal equipment is schematically given in FIG. 2).

In the embodiments of this disclosure, existing traffics or traffics that may be implemented in the future may be performed between the network device 201 and the terminal equipment 202. For example, such traffics may include but not limited to enhanced mobile broadband (eMBB), massive machine type communication (MTC), and ultra-reliable and low-latency communication (URLLC), etc.

The terminal equipment 202 may transmit data to the network device 201, such as in a grant or grant-free manner. The network device 201 may receive data transmitted by one or more terminal equipments 202, and feed back information to the terminal equipment 202, such as acknowledgement (ACK)/non-acknowledgement (NACK) information, and the terminal equipment 202 may acknowledge to terminate a transmission process, or may perform transmission of new data, or may perform data retransmission.

In the following description of this disclosure, an artificial intelligence (AI) model may also be referred to as an artificial intelligence/machine learning (AI/ML) model, and they may be replaced mutually.

In the embodiments described below, signaling transmitted by the network device to the terminal equipment may be transmitted via downlink control information (DCI), a media access control control element (MAC CE), and/or radio resource control (RRC) signaling.

In the following embodiments of this disclosure, there exists a pairing relationship between an AI/ML-based CSI generation portion and an AI/ML-based CSI reconstruction portion, the former being applicable to a terminal equipment side, and the latter being applicable to a network device side. If the terminal equipment uses an AI/ML-based CSI generation portion, the network device must use an AI/ML-based CSI reconstruction portion paired with the AI/ML-based CSI generation portion to successfully reconstruct channel information. And if the network device uses an AI/ML-based CSI reconstruction portion, the terminal equipment must use an AI/ML-based CSI generation portion paired with the AI/ML-based CSI reconstruction portion to successfully reconstruct channel information at the network device side.

The AI/ML-based CSI generation portion includes an AI/ML model, which may be used to generate one or more of precoding matrix information, a rank indicator (RI), a layer indicator (LI), a channel resource indicator (CRI), and a channel quality indicator (CQI). In addition, the RI, LI, CRI and CQI may not be generated by the AI/ML model. For example, the AI/ML-based CSI generation portion may further include one or more of a module generating an RI, a module generating an LI, a module generating a CRI, and a module generating a CQI. The AI/ML-based CSI generation portion may further include other modules, such as a module for truncating bit sequences.

The information of the AI/ML-based CSI generation portion may be composed of AI/ML model information and/or information of the module generating an RI and/or information of the module generating an LI and/or information of the module generating a CRI and/or information of the module generating a CQI and/or information of a module truncating a bit sequence and/or information of other functional modules (if any).

The AI/ML model may include three parts, a preprocessing module, an AI/IL encoder and a quantizer. Therefore, AI/ML model information may include preprocessing module information, AI/ML encoder information and quantizer information. For example, the AI/ML model information may be described by “preprocessing module #2, AI/ML encoder #4, quantizer #A”. In addition, the preprocessing module, AI/MVL encoder and quantizer may be regarded as a whole to annotate the AI/ML model information, that is, the AI/MVL model information may also be expressed as, for example, AI/ML model information #4, etc.

The AI/ML-based CSI reconstruction model of the AI/ML-based CSI reconstruction portion paired with the AI/ML-based CSI generation portion may also include three parts, a dequantizer, an AI/ML decoder, and a post-processing module. Therefore, the AI/ML reconstruction model information may include dequantizer information, AI/ML decoder information, and post-processing module information. For example, the AI/ML reconstruction model information may be described by “dequantizer #B, AI/IL decoder #1, post-processing module #2”. In addition, the AI/ML reconstruction model information may also be expressed as, for example, AI/ML reconstruction model #1, or AI/ML model #1 in brief, so as to express the pairing relationship with AI/ML model #1 in the AI/ML-based CSI generation portion.

The AI/ML model may also be composed of two parts (for example, it has no preprocessing module, or a preprocessing module is included in the AI/ML encoder and is regarded as a whole with the AI/ML encoder), that is, the AI/ML model includes an AI/ML encoder and a quantizer. At this point, the AI/ML model information may be composed of AI/ML encoder information and quantizer information. The AI/ML-based CSI reconstruction model of the AI/ML-based CSI reconstruction portion paired with the AI/ML model may also consist of two parts, i.e., a dequantizer and an AI/ML decoder. At this point, the AI/MVL reconstruction model information consists of dequantizer information and AI/ML decoder information. The preprocessing module may be included in the AI/ML encoder, or may not be included in the AI/ML encoder. The post-processing module may be included in the AI/ML decoder or may not be included in the AI/ML decoder.

The AI/ML model may also be composed of one part, that is, the AI/ML encoder and quantizer are regarded as a whole (for example, the AI/ML encoder and quantizer are inseparable and cannot be freely combined), and the AI/ML encoder may or may not include a preprocessing module. At this point, the AI/ML model information consists of one part only, for example, the AI/ML model information is AI/ML model #5. The AI/ML reconstruction model may also be composed of one part, that is, the dequantizer and AI/ML decoder are regarded as a whole (for example, the AI/ML decoder and dequantizer are inseparable and cannot be freely combined), and the AI/ML decoder may or may not include a post-processing module. At this point, the AI/ML reconstruction model information consists of one part only, for example, the AI/ML reconstruction model information is AI/MVL reconstruction model #5, or AI/ML model #5 in brief, so as to express the pairing relationship with AI/ML model #5 in the AI/ML-based CSI generation portion.

In the embodiments of this disclosure, it is assumed that frequency domain resources are fixed, that is, carrier frequencies, subcarrier spacings and bandwidths are fixed. In addition, this disclosure is not limited thereto, for example, description of the embodiments is also applicable to scenarios where at least one of the carrier frequencies, subcarrier spacings and bandwidths is not fixed.

In various embodiments of this disclosure, reporting may refer to an action of transmitting information by the terminal equipment to the network device. For example, reporting CSI by the terminal equipment may refer to transmitting CSI by the terminal equipment to the network device.

In various embodiments of this disclosure, the number of downlink transmission layers may also be referred to as the number of spatial layers of CSI feedback, they have the same meaning, and may be replaced mutually in various embodiments.

### Embodiments of a First Aspect

The embodiments of the first aspect provide a method for transmitting channel state information, applicable to a terminal equipment, such as the terminal equipment 202 in FIG. 2.

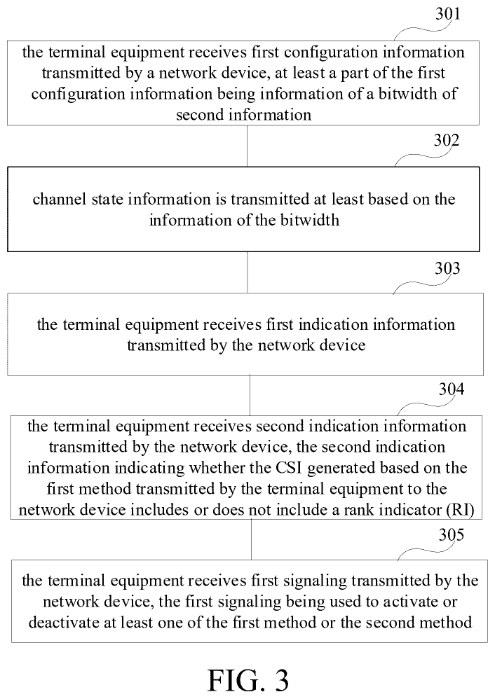

FIG. 3 is a schematic diagram of the method for transmitting channel state information (CSI) of the embodiments of the first aspect of this disclosure. As shown in FIG. 3, the method includes:
301: the terminal equipment receives first configuration information transmitted by a network device, at least a part of the first configuration information being information of a bitwidth of second information; and
302: channel state information is transmitted at least based on the information of the bitwidth.

In this disclosure, the second information includes channel state information (CSI) and/or precoding matrix information.

In this disclosure, the information of a bitwidth of second information may include: a bitwidth of the second information, and/or two or more candidate values of the bitwidth of the second information, and/or a maximum value of the bitwidth of the second information, and/or a parameter and/or configuration that is/are able to calculate the maximum value of the bitwidth of the second information. For example, the parameter and/or configuration that is/are able to calculate the maximum value of the bitwidth of the second information include(s) information on a model used for generating the channel state information and/or information on a second method.

In at least one embodiment, the first configuration information includes configuration information generating the CSI based on a first method and/or configuration information generating the CSI based on a second method, wherein at least one of the first method or the second method is activated, that is, the terminal equipment generates the CSI based on at least one of the first method or the second method.

At least a part of the first method is a method based on an artificial intelligence model. The second method is a method obtained by a codebook specified in the 3GPP standardization or obtained by revising a value range of at least one parameter of a codebook specified in the 3GPP standardization.

In at least one embodiment, the terminal equipment may obtain the information of a bitwidth of second information generating CSI based on the first method according to the configuration information generating CSI based on the second method.

The terminal equipment obtains a maximum value of the bitwidth of the second information generating CSI based on the first method according to the configuration information generating CSI based on the second method and a maximum value of the number of supported downlink transmission layers.

In at least one implementation, a maximum value of the supported downlink transmission layers to which the first method corresponds is identical to or different from a maximum value of the supported downlink transmission layers to which the second method corresponds. In addition, the maximum value of the supported downlink transmission layers to which the first method corresponds is predetermined or is configured by the network device.

As shown in FIG. 3, the method for transmitting channel state information further includes:
303: the terminal equipment receives first indication information transmitted by the network device.

The first indication information indicates the terminal equipment to transmit first information, at least a part of the first information being: a bitwidth of precoding matrix information generating CSI based on the first method and/or a bitwidth of respective precoding vector information of all transmission layers of more than one downlink transmission layer.

As shown in FIG. 3, the method for transmitting channel state information further includes:
304: the terminal equipment receives second indication information transmitted by the network device, the second indication information indicating whether the CSI generated based on the first method transmitted by the terminal equipment to the network device includes or does not include a rank indicator (RI).

For example, when the second indication information indicates that the CSI generated based on the first method transmitted by the terminal equipment to the network device includes a rank indicator (RI), the terminal equipment reports the RI and a non-zero CSI payload size to the network device.

For another example, when the second indication information indicates that the CSI generated based on the first method transmitted by the terminal equipment to the network device does not include a rank indicator (RI), the terminal equipment reports CSI payload sizes of all layers to the network device.

As shown in FIG. 3, the method for transmitting channel state information further includes:
305: the terminal equipment receives first signaling transmitted by the network device, the first signaling being used to activate or deactivate at least one of the first method or the second method.

For example, the first signaling includes at least one field, the field including at least one bit to activate or deactivate at least one of the first method or the second method.

The first signaling is, for example, downlink control information (DCI) signaling or media access control control element (MAC CE) signaling.

In at least another embodiment, the terminal equipment obtains the information on the bitwidth of the second information generating CSI based on the first method according to the information on the model used for generating the channel state information.

The information on the model used for generating the channel state information includes information on an artificial intelligence (AI/ML) model and/or information on a quantizer.

The information on the artificial intelligence model includes: the number or a maximum value of first elements output by the artificial intelligence model, and/or a type of the first elements (such as an integer number, a floating point number, and a double-precision floating point number, etc.). An output of the artificial intelligence model is an input of the quantizer.

The information on a quantizer includes: a quantization method (such as scalar quantization, or vector quantization), and/or a quantization type (such as uniform quantization, or non-uniform quantization), and/or a quantization precision.

In at least one implementation,
at least a part of the information on the artificial intelligence model and at least a part of the information on the quantizer are configured in a combined manner; and/or
at least a part of the information on the artificial intelligence model and at least a part of the information on the quantizer are configured independently of each other.

For example, at least a part of the information on the artificial intelligence model is set as a table, and at least a part of the information on the quantizer is set as a table; or, at least a part of the information on the artificial intelligence model is combined with at least a part of the information on the quantizer to set as a table.

In at least another embodiment, the first configuration information includes information on one or more models generating channel state information based on the first method, and/or the maximum value of the number of supported downlink transmission layers generating CSI based on the first method. The terminal equipment determines a maximum value of bitwidths of bit sequences output by the one or more models according to the information on the one or more models, and obtains the information on the bitwidth of the second information generating CSI based on the first method according to the maximum value of bitwidths of bit sequences output by the one or more models and the maximum value of the number of supported downlink transmission layers generating CSI based on the first method.

When the model has a scalability for the bitwidth of the output bit sequence, the terminal equipment may take a maximum bitwidth of one or more output bit sequences of the model as a bitwidth of an output bit sequence of the model having a scalability for the bitwidth of the output bit sequence.

In at least one further embodiment,
the first configuration information includes a first field, the first field being used to indicate a value of the bitwidth of the second information; and/or
the first configuration information includes a second field, the second field being used to indicate two or more candidate values of the bitwidth of the second information; and/or
the first configuration information includes a third field, the third field being used to indicate the maximum value of the bitwidth of the second information.

This disclosure shall be further described with reference to different embodiments.

### Embodiment 1

An allowable maximum value of a bitwidth of precoding matrix information configured by the network device may be given by a codebook configuration.

In some implementations, the network device transmits configuration information to the terminal equipment, the configuration information being CSI report configuration information or first configuration information. The first configuration information includes information on a payload of uplink control information (UCI), such as a payload value of the UCI, a maximum value of a payload of the UCI, a set consisting of available payload values of one or more pieces of the UCI, and a payload value of the UCI that can be calculated or a parameter of a maximum value, etc., and/or information on a CSI generation model. The configuration information is transmitted via RRC signaling, and the first configuration information may include configuration information generating CSI based on an AI/ML method (i.e. the first method) and configuration information generating CSI based on the second method, wherein one or more of generating CSI based on the AI/ML method and generating CSI based on the second method are activated.

In some implementations, generating CSI based on the AI/ML method and/or generating CSI based on the second method is/are activated by using DCI and/or an MAC CE. The second method is a method obtained by a codebook specified in the 3GPP standardization or obtained by revising a value range of at least one parameter of a codebook specified in the 3GPP standardization. The parameter includes, for example, parameters L, pᵥ, β, amplitude coefficient indications i_{2, 3, l}, i_{2, A, l}, and a phase coefficient indication, i_{2, 5, l}, etc., given in sub-section 5.2 of 3GPP Standard Document 38.214; where, l=1, 2, . . . , v, values v of being shown in Table 5.2.2.2.5-1 given in sub-section 5.2 of 3GPP Standard Document 38.214.

The method obtained by revising a value range of at least one parameter of the codebook specified in the 3GPP standardization may be expanding a value range of at least one parameter of a codebook specified in the 3GPP standardization, or removing at least one value in a value range of at least one parameter of a codebook specified in the 3GPP standardization, or removing at least one value in a value range of at least one parameter of a codebook specified in the 3GPP standardization and adding at least one possible value. For example, the parameters L, pᵥ, B given in sub-section 5.2 of 3GPP Standard Document 38.214 are given in Table 5.2.2.2.5-1. The changed value ranges of the three parameters may be those given in Table 1 or Table 2, which are illustrative only; however, they are not limited thereto.

TABLE 1

| | | p_{ν} | | |
|---|---|---|---|---|
| paramCombination-r16-revise | L | ν ∈ {1, 2} | ν ∈ {3, 4} | β |
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | ½ |
| 5 | 4 | ¼ | ¼ | ¾ |
| 6 | 4 | ½ | ¼ | ½ |
| 7 | 6 | ¼ | — | ½ |
| 8 | 6 | ¼ | — | ¾ |
| 9 | 6 | ¼ | ¼ | ½ |
| 10 | 7 | ½ | ¼ | ¾ |
| 11 | 8 | 0.9 | — | ⅘ |
| 12 | 5 | ½ | ¼ | ¼ |

TABLE 2

| | | p_{ν} | | |
|---|---|---|---|---|
| paramCombination-r16-revise | L | ν ∈ {1, 2} | ν ∈ {3, 4} | β |
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | ¾ |
| 5 | 4 | ¼ | ¼ | ¾ |
| 6 | 4 | ½ | ¼ | ½ |
| 7 | 6 | ¼ | ⅛ | ½ |
| 8 | 6 | ¼ | ¼ | ¾ |

For another example, revising a value range of at least one parameter of a codebook specified in the 3GPP standardization may also be implemented by revising the amplitude coefficient indications i_{2, 3, l}, i_{2, A, l} and/or the phase coefficient indication, i_{2, 5, l}. Ranges of values to which the amplitude coefficient indications and/or the phase coefficient indication correspond(s) may be implemented ed by revising the number of selectable values and/or specific values of them. For example, for each l=1, 2, . . . , v, values i_{2, 3, l} of are given as follows in sub-section 5.2 of 3GPP Standard Document 38.214:

$${i}_{2 , 3 , i} = [ {k}_{l , 0}^{( 1 )} , {k}_{l , 1}^{( 1 )} ] ,$$

$${k}_{l , p}^{( 1 )} ∈ \{ 1 , 2 , … , 15 ) , p = 1 , 2 ,$$

$${p}_{l}^{( 1 )} = [ {p}_{l , 0}^{( 1 )} , {p}_{l , 1}^{( 1 )} ] ;$$

where

$${k}_{l , p}^{( 1 )}$$

denotes an index, and

$${p}_{l , p}^{( 1 )}$$

denotes a value to which the index

$${k}_{l , p}^{( 1 )}$$

corresponds. Mapping from

$${k}_{l , p}^{( 1 )}$$

table

$${p}_{l , p}^{( 1 )}$$

to is given in Table 5.2.2.2.5-2 of 3GPP Standard Document 38.214, as shown in Table 3 below.

TABLE 3

| ${k}_{l , p}^{( 1 )}$ | ${p}_{l , p}^{( 1 )}$ |
|---|---|
| 0 | Reserved |
| 1 | $\frac{1}{\sqrt{128}}$ |
| 2 | ${( \frac{1}{8192} )}^{1 / 4}$ |
| 3 | $\frac{1}{8}$ |
| 4 | ${( \frac{1}{2048} )}^{1 / 4}$ |
| 5 | $\frac{1}{2 \sqrt{8}}$ |
| 6 | ${( \frac{1}{512} )}^{1 / 4}$ |
| 7 | $\frac{1}{4}$ |
| 8 | ${( \frac{1}{128} )}^{1 / 4}$ |
| 9 | $\frac{1}{\sqrt{8}}$ |
| 10 | ${( \frac{1}{32} )}^{1 / 4}$ |
| 11 | $\frac{1}{2}$ |
| 12 | ${( \frac{1}{8} )}^{1 / 4}$ |
| 13 | $\frac{1}{\sqrt{2}}$ |
| 14 | ${( \frac{1}{2} )}^{1 / 4}$ |
| 15 | 1 |

Revising the value range of i_{2, 3, l} specified in 3GPP standardization may be revising only the value range of i_{2, 3, l} without revising the value range of i_{2, 3, 2}, or revising value ranges of all l=1, 2, . . . , v, i_{2, 3, l}, or may be other possible revising. A value of

$${p}_{l , p}^{( 1 )}$$

in Table 5.2.2.2.5-2 may only be revised, such as revising contents shown in Table 4 below.

TABLE 4

| ${k}_{l , p}^{( 1 )}$ | ${p}_{l , p}^{( 1 )}$ |
|---|---|
| 0 | Reserved |
| 1 | $1 / 16$ |
| 2 | ${( \frac{1}{8192} )}^{1 / 4}$ |
| 3 | $\frac{1}{8}$ |
| 4 | ${( \frac{1}{2048} )}^{1 / 4}$ |
| 5 | $\frac{1}{2 \sqrt{8}}$ |
| 6 | ${( \frac{1}{512} )}^{1 / 4}$ |
| 7 | $\frac{1}{4}$ |
| 8 | ${( \frac{1}{128} )}^{1 / 4}$ |
| 9 | $\frac{1}{\sqrt{8}}$ |
| 10 | ${( \frac{1}{32} )}^{1 / 4}$ |
| 11 | $\frac{1}{2}$ |
| 12 | ${( \frac{1}{8} )}^{1 / 4}$ |
| 13 | $\frac{1}{\sqrt{2}}$ |
| 14 | ${( \frac{1}{2} )}^{1 / 4}$ |
| 15 | 1 |

The value range of

$${k}_{l , p}^{( 1 )}$$

and values of

$${p}_{l , p}^{( 1 )}$$

in Table 5.2.2.2.5-2 may also be revised, for example,

$${k}_{l , p}^{( 1 )} ∈ \{ 1 , 2 , … , 16 ] * p = 1 , 2.$$

Correspondingly, values of

$${p}_{l , p}^{( 1 )}$$

and mapping from

$${k}_{l , p}^{( 1 )}$$

table to

$${p}_{l , p}^{( 1 )}$$

may also be revised. An example is to add the following Table 5 to Table 5.2.2.2.5-2 (Table 3).

TABLE 5

| | |
|---|---|
| ${k}_{l , p}^{( 1 )}$ | ${p}_{l , p}^{( 1 )}$ |

| | |
|---|---|
| 16 | 1/16 |

An allowable maximum value of the bitwidth of the precoding matrix information generated based on the codebook may be obtained via the configuration information generating CSI based on the second method. In this disclosure, the terminal equipment obtains an allowable maximum value of the bitwidth of the precoding matrix information generated based on AI/ML via the configuration information generating CSI based on the second method.

In some implementations, a limitation (or a maximum value) of a spatial layer performing CSI feedback based on the AI/ML method is identical to a limitation (or a maximum value) of a spatial layer performing CSI feedback based on the second method, where the spatial layer is also referred to as a downlink transmission layer, and the limitation (or a maximum value) of the spatial layer is also referred to as a maximum value of a supported downlink transmission layer. In this implementation, the former (i.e. the limitation or the maximum value of a spatial layer performing CSI feedback based on the AI/ML method) may be given in the first configuration information, or may not be given in the first configuration information, for example, it may be predetermined.

In some implementations, the limitation (or a maximum value) of a spatial layer performing CSI feedback based on the AI/ML method and the limitation (or a maximum value) of spatial layer performing CSI feedback based on the second method are different. In this implementation, the former is given in the first configuration information.

For example, the RRC signaling includes: configuration information used for the terminal equipment to generate CSI based on the AI/ML method when instructed by the network device, and configuration information used for generating CSI based on the second method. In this example, the second method is the enhanced type II codebook specified in the 3GPP standardization, and a value of paramCombination-r16 is 4, wherein a value range of paramCombination-r16 is given in Table 5.2.2.2.5-1 in 3GPP TS38.214, as shown in Table 6 below.

TABLE 6

| | | p_{ν} | | |
|---|---|---|---|---|
| paramCombination-r16 | L | ν ∈ {1, 2} | ν ∈ {3, 4} | β |
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | ½ |
| 5 | 4 | ¼ | ¼ | ¾ |
| 6 | 4 | ½ | ¼ | ½ |
| 7 | 6 | ¼ | — | ½ |
| 8 | 6 | ¼ | — | ¾ |

N₁=8 N₂=2, O₁=4 and O₂=4 are selected as antenna configurations. The second method gives R=1 via a high-layer parameter numberOfPMI-SubbandsPerCQI-Subband, and gives the number 13 of subbands via a high-layer parameter csi-ReportingBand. Hence, a total number of precoding matrices is N₃=N_{sb}R=13. As specified in standards, a limitation of a spatial layer performing CSI feedback by using an enhanced type II codebook is 4, i.e. a maximum value of values to which a rank indicator (RI) corresponds is 4. Thus, an allowable maximum value of the bitwidth of the precoding matrix information of the CSI generated based on the second method is 319 bits, which may be obtained by calculating by the contents contained in Clause 6.3 in the 3GPP technical specification 38.212 V17.5.0.

In this disclosure, the allowable maximum value of the bitwidth of the precoding matrix information of the CSI generated based on the AI/ML method is identical to the allowable maximum value of the bitwidth of the precoding matrix information of the CSI generated based on the second method, or, in other words, the former is obtained from parameters and a calculation method of the latter. Thus, the allowable maximum value of the bitwidth of the precoding matrix information of the CSI generated based on the AI/NL method is also 319 bits. The terminal equipment generates and transmits CSI according to the allowable maximum value of the bitwidth of the precoding matrix information of the CSI generated based on the AI/ML method and the information on the CSI generation model. The information on the CSI generation model may be configured by the network device by transmitting information to the terminal equipment, or may be selected and transmitted to the network device by the terminal equipment, or may be specified in a standard document.

The limitation (or the maximum value) of the spatial layer of the CSI feedback based on AI/ML is given by the second method, hence, the limitation (or the maximum value) of the spatial layer of the CSI feedback based on AI/MVL is identical to the limitation (or the maximum value) of the spatial layer of the CSI feedback based on codebooks. In this embodiment, the second method given by the first configuration information is an enhanced type II codebook, hence, the limitation (or the maximum value) of the spatial layer of the CSI feedback based on AI/ML is 4.

The limitation (or the maximum value) of the spatial layer of the CSI feedback based on AI/ML is given by the first configuration information, hence, there exists no association between the limitation (or the maximum value) of the spatial layer of the CSI feedback based on AI/ML and the limitation (or the maximum value) of the spatial layer of the CSI feedback based on codebooks. The limitation (or the maximum value) of the spatial layer of the CSI feedback based on AI/ML may be greater than or equal to or less than the limitation (or the maximum value) of the spatial layer of the CSI feedback based on codebooks. In this embodiment, the second method given by the first configuration information is an enhanced type II codebook, hence, the limitation (or the maximum value) of the spatial layer of the CSI feedback based on AI/ML may be any one of 1, 2, 3, 4, 5, 6, 7, 8, . . . , 20.

In some embodiments, the first configuration information transmitted by the network device to the terminal equipment further includes: indicating the terminal equipment by the network device to transmit first information (e.g. actually transmitted by the terminal equipment), wherein the first information refers to the bitwidth of the precoding matrix information generated based on AI/ML and/or a bitwidth of respective precoding vector information of all transmission layers of more than one downlink transmission layers.

In some implementations, a value of a CSI reporting amount of the method for generating CSI based on AI/ML in the first configuration information transmitted by the terminal equipment to the network device as indicated by the network device may or may not include an RI.

For example, the value of a CSI reporting amount of the method for generating CSI based on AI/ML in the first configuration information transmitted by the terminal equipment to the network device as indicated by the network device does not include an RI.

The network device indicates the terminal equipment to transmit the first information, the first information including a bitwidth of respective precoding vector information of all transmission layers (generated based on AI/ML) of downlink transmission, and the number of all the transmission layers is the limitation (the maximum value) of the spatial layer of CSI feedback based on AI/ML (of the CSI generated based on the AI/ML method), i.e. a maximum value of values to which the RI corresponds. For example, the limitation (the maximum value) of the spatial layer of CSI feedback based on AI/MVL is 3, and a rank of a spatial channel matrix obtained by the terminal equipment through received CSI-RS measurement is 2. The terminal equipment transmits the first information to the network device according to the first configuration information (the value of CSI reporting amount of method for generating CSI based on AI/ML does not include an RI), i.e. the bitwidths of the respective precoding vector information of all the transmission layers (generated based on AI/ML) of downlink transmission, are 120, 100, 0, representing that a bitwidth of a first layer of precoding vector information is 120 bits, a bitwidth of a second layer of precoding vector information is 100 bits, and a bitwidth of a third layer of precoding vector information is 0 bits. As 120+100+0=220<319 bits, the bitwidth of the precoding matrix information generated by the terminal equipment is smaller than its allowable maximum value, which satisfies requirements. It is noted that the bitwidth of the third layer of the precoding vector information is 0 bits, it may be learnt that a value to which the RI corresponds is 2, in other words, the terminal equipment does not need to report RI, and the network device may learn that the value to which the RI corresponds is 2.

For another example, the value of a CSI reporting amount of the method for generating CSI based on AI/ML in the first configuration information transmitted by the terminal equipment to the network device as indicated by the network device includes an RI.

The network device indicates the terminal equipment to transmit the first information, the first information including a bitwidth of respective precoding vector information of all transmission layers (generated based on AI/ML) of downlink transmission, and the number of all the transmission layers is the value to which the RI corresponds. For example, the limitation (the maximum value) of the spatial layer of CSI feedback based on AI/ML is 3, and a rank of a spatial channel matrix obtained by the terminal equipment through received CSI-RS measurement is 2. The terminal equipment transmits the first information to the network device according to the first configuration information (the value of CSI reporting amount of method for generating CSI based on AI/ML does not include an RI), i.e. the bitwidths of the respective precoding vector information of all the transmission layers (generated based on AI/ML) of downlink transmission, are 120, 100, 0, representing that a bitwidth of a first layer of precoding vector information is 120 bits, and a bitwidth of a second layer of precoding vector information is 100 bits. As 120+100=220<319 bits, the bitwidth of the precoding matrix information generated by the terminal equipment is smaller than its allowable maximum value, which satisfies requirements. The first information transmitted by the terminal equipment further includes that a value to which the RI corresponds is 2. Hence, the network device may learn bit information in the first information which is the bitwidths of the respective precoding vector information of all the transmission layers of downlink transmission.

In some implementations, generating CSI based on the AI/ML method and/or generating CSI based on the second method is/are activated by using DCI and/or an MAC CE.

For example, the network device transmits first signaling (such as DCI or an MAC CE) to the terminal equipment, the first signaling being used to indicate opening and/or closing of the AI/ML based CSI feedback and/or the second method. For example, the first signaling includes a field, which may be described by 1 bit, as shown in Table 7 below.

TABLE 7

| First signaling | Indicated contents |
|---|---|
| 0 | Opening the AI/ML based CSI feedback and |
| | closing the second method |
| 1 | Closing the AI/ML based CSI feedback and |
| | opening the second method |

When a value of the field of the first signaling is 0, it indicates opening the AI/ML based CSI feedback and closing the second method, and when a value of the field of the first signaling is 1, it indicates closing the AI/ML based CSI feedback and opening the second method. For another example, the first signaling includes a field, which may be described by 2 bits, as shown in Table 8 below.

TABLE 8

| First signaling | Indicated contents |
|---|---|
| 00 | Opening the AI/ML based CSI feedback and |
| | closing the second method |
| 01 | Closing the AI/ML based CSI feedback and |
| | opening the second method |
| 10 | Opening the AI/ML based CSI feedback and |
| | opening the second method |
| 11 | Closing the AI/ML based CSI feedback and |
| | closing the second method |

When a value of the field of the first signaling is 10, it indicates opening the AI/ML based CSI feedback and opening the second method.

Embodiment 1 is conducive to achieving “coexistence of generating CSI based on AI/ML and generating CSI based on the second method”. Specifically,
a) configurations based on AI/ML and based on the second method are given together in one piece of RRC signaling, but one of the methods may be activated. If it is needed to switch to another method, it may be activated/deactivated by DCI or an MAC CE, and reconfiguring RRC signaling is not needed, thereby improving efficiencies.
b) by determining the allowable maximum value of the bitwidth of the precoding matrix information of the AI method by the configuration of the second method, the bitwidths of the precoding matrix information of the two methods are made close and have identical maximum values, with identical requirements on uplink resources. If it is needed to switch to another method, there is no need to reconfigure uplink resources.

### Embodiment 2

In some implementations, at least a part of the first configuration information transmitted by the network device to the terminal equipment is the information on the CSI generation model, which includes information on the AI/ML model and/or information on a quantizer. The second information, such as the allowable maximum value of the precoding matrix information, may be obtained from the information on the CSI generation model.

The information on the AI/ML model includes the number (or a maximum value) of first elements output by it and/or a type of the first elements (such as an integer number, a single-precision floating point number, and a double-precision floating point number, etc.). The first elements are inputs of the quantizer.

At least a part of the information on a quantizer is a quantization method (such as scalar quantization, or vector quantization), a quantization type (such as uniform quantization, or non-uniform quantization), and a quantization precision. For the scalar quantization, the quantization precision is the number of bits used in describing an A-th element (such as an integer number, a single-precision floating point number, and a double-precision floating point number, etc.). For the scalar quantization, the uniform quantization refers to using identical quantization precision to quantize each A-th element, such as using 4-bit to quantize each A-th element. The non-uniform quantization refers to using different quantization precision to quantize at least two elements, such as quantizing element 1 by using 3 bits and quantizing element 2 into two bits. For the vector quantization, the quantization precision is the number of bits used in describing a vector, the vector consisting of one or more A-th elements. For example, vector quantization is performed on a sequence α₁α₂ . . . α_{N} (where, N>1) consisting of double-precision floating point numbers (referred to as sequence 1) to divide the sequence 1 into M vectors, referred to as B₁=(α₁, . . . , αₓ_{₁}), B₂=α_{K}_{₁}₊₁, . . . , α_{K}_{₂}), . . . , B_{M-1}=(α_{K}_{_{M−2}}₊₁, . . . , α_{K}_{_{M−1}}), B_{M}=(α_{K}_{_{M−1}}₊₁, . . . , α_{N}). Vector B₁ is described by using 3 bits, hence, the 3 bits are quantization precision of the vector. Codebooks of the vector quantization may be configured by the network device, or may be specified in standards, or may be selected and reported by the terminal equipment, or may be obtained by being trained together with the AI/ML model. For the vector quantization, the uniform quantization refers to that lengths of vectors Bₖ (where, k=1, 2, . . . , M) are identical, and the vectors are quantized with the same quantization precision, such as quantizing each vector Bₖ by using 4-bits. The non-uniform quantization refers to that at least two vectors Bₘ, Bₙ (where, m≠n) have different lengths, and/or, Bₘ, Bₙ are quantized with different quantization precision, such as quantizing vector Bₘ by using 3 bits, and quantizing vector Bₙ into 2 bits.

In some implementations, the information on the AI/ML model and the information on the quantizer may be configured separately, or jointly, or partially jointly. For example, in the case of separate configuration, an index may be configured from each of tables 9-13. For example, the information on the CSI generation model of the terminal equipment configured by the network device is:
outputting 30 double-precision floating point numbers by the AI/ML model;
using uniform scalar quantization, with a quantization precision of 5 bits.

And the network device configures that all spatial layers use identical CSI generation models.

Hence, the configuration information of the CSI generation model by the network device is as follows: index 2 (bit sequence: 01) in Table 9, index 1 (bit sequence: 0) in Table 10, index 4 (bit sequence: 101) in Table 11, and index 1 (bit sequence: 1) in Table 12. These indices are expressed by using bit sequences, and one of methods is arranging them in an order of tables 9 to 13 (which may be specified in standards), which are 0101011.

Assuming that the limitation (the maximum value) of the spatial layer of the CSI feedback based on AI/ML is 2, a bitwidth output by the CSI generation model (consisting of the AI/ML model and quantizer) is 150 bits, and the allowable maximum value of the bitwidth of the precoding matrix information of the CSI generated based on AI/ML is 300 bits.

Assuming that the AI/ML-based reporting amount configured by the network device is channel state information reference signal resource indicator (CSI-RS resource indicator, CRI), a rank indicator (RI), precoding matrix information, and a channel quality indicator (CQI), wherein bitwidths of the CRI, RI and CQI are 2 bits, 2 bits and 30 bits, respectively. The allowable maximum value of the bitwidth of the CSI generated based on AI/ML in this embodiments is 300+2+2+30=334 bits.

For another example, the information on the CSI generation model of the terminal equipment configured by the network device is:
outputting 80 double-precision floating point numbers by the AI/ML model;
using non-uniform vector quantization, wherein a quantization precision is 7 bits, and a minimum value of a vector length of the vector quantization is 8.

And the network device configures that all spatial layers use identical CSI generation models.

Hence, the configuration information of the network device is as follows: index 4 in Table 9 (bit sequence: 11), index 2 in Table 10 (bit sequence: 1), index 5 in Table 11 (bit sequence: 111), index 2 in Table 12 (bit sequence: 0), index 4 in Table 13 (bit sequence: 011). These indices are expressed by using bit sequences, and one of methods is arranging them in an order (which may be specified in standards), such as arranging them in an order of Table 11, Table 10, Table 9, Table 12, and Table 13 at one time, which is 1111110011. From “1” in a 4th bit of the bit sequence, it may be learnt that the quantization method is vector quantization, hence, it may be learnt that the bit sequence includes information on Table 13, hence, an 8th to 11th bits represent an index of Table 13. From “0” in a 7th bit of the bit sequence, it may be learnt that the quantization type is non-uniform quantization, hence, an index of Table 11 described by the 1st to 3rd bits means a maximum value of quantization precision, and the 8th to 11th bits represent a minimum value of a vector length of the vector quantization.

Assuming that the limitation (the maximum value) of the spatial layer of the CSI feedback based on AI/ML is 4, a maximum value of a bitwidth output by the CSI generation model (consisting of the AI/ML model and quantizer) is 80÷8×7=70 bits, and the allowable maximum value of the bitwidth of the precoding matrix information of the CSI generated based on AI/ML is 280 bits.

TABLE 9
The number (or a maximum value) of the first
elements output by the AI/ML model

| | Bit representations | The number (or a maximum |
|---|---|---|
| Indices | of indices | value) of the first elements |
| 1 | 00 | 20 |
| 2 | 01 | 30 |
| 3 | 10 | 45 |
| 4 | 11 | 80 |

TABLE 10
Quantization method

| | Bit representations | |
|---|---|---|
| Indices | of indices | Quantization method |
| 1 | 0 | Scalar quantization |
| 2 | 1 | Vector quantization |

TABLE 11
Quantization precision (or a maximum value)

| | Bit representations | Quantization precision |
|---|---|---|
| Indices | of indices | (or a maximum value) |
| 1 | 000 | 2 bits |
| 2 | 011 | 3 bits |
| 3 | 100 | 4 bits |
| 4 | 101 | 5 bits |
| 5 | 111 | 7 bits |

TABLE 12
Quantization types

| | Bit representations | |
|---|---|---|
| Indices | of indices | Quantization types |
| 1 | 1 | Uniform quantization |
| 2 | 0 | Non-uniform quantization |

TABLE 13
Vector lengths (or minimum values) of vector quantization

| | | Vector lengths (or |
|---|---|---|
| | Bit representations | minimum values) of |
| Indices | of indices | vector quantization |
| 1 | 000 | 2 |
| 2 | 001 | 3 |
| 3 | 010 | 5 |
| 4 | 011 | 8 |
| 5 | 100 | 16 |

For a further example, the case of joint configuration may be configuring an index in Table 14. For example, it is assumed that the limitation (maximum value) of the spatial layer of the AI/ML-based CSI feedback is 3, and the network device configures that at least 2 spatial layers use different CSI generation models. The network device configures indices 4, 3 and 1, and their bit representations are 001, 100 and 100000, respectively. Allowable maximum values of bitwidths of precoding matrix information generated by the three CSI generation models are 60 bits, 50 bits, 40 bits, respectively Thus, the allowable maximum value of the bitwidth of the precoding matrix information of the CSI generated based on AI/ML is 60+50+40=bits.

TABLE 14
Joint Configuration of the CSI generation model

| | | The number | | | | |
|---|---|---|---|---|---|---|
| | | (or a | | | | |
| | | maximum | | | | |
| | | value) of | | | | |
| | | the first | | | | Vector |
| | | elements | | Quantization | | lengths (or |
| | | output by | | precision | | minimum |
| | Bit | the | | (or a | | values) of |
| | representations | AI/ML | Quantization | maximum | Quantization | vector |
| Indices | of indices | model | method | value) | types | quantization |
| 1 | 0000 | 20 | Scalar | 2 bits | Uniform | N.A. |
| | | | quantization | | quantization | |
| 2 | 0001 | 20 | Vector | 3 bits | Uniform | 5 |
| | | | quantization | | quantization | |
| 3 | 0010 | 20 | Vector | 5 bits | Non-uniform | 2 |
| | | | quantization | | quantization | |
| 4 | 0011 | 30 | Scalar | 2 bits | Uniform | N.A. |
| | | | quantization | | quantization | |
| 5 | 0100 | 30 | Vector | 7 bits | Uniform | 3 |
| | | | quantization | | quantization | |
| 6 | 0101 | 40 | Vector | 7 bits | Uniform | 5 |
| | | | quantization | | quantization | |
| 7 | 0111 | 80 | Scalar | 2 bits | Uniform | N.A. |
| | | | quantization | | quantization | |
| 8 | 1000 | 80 | Scalar | 3 bits | Non-uniform | N.A. |
| | | | quantization | | quantization | |
| 9 | 1001 | 80 | Vector | 4 bits | Non-uniform | 2 |
| | | | quantization | | quantization | |
| 10 | 1010 | 80 | Vector | 5 bits | Non-uniform | 5 |
| | | | quantization | | quantization | |

For still another example, the case of joint configuration may be configuring an index in each of tables 9 and 15.

TABLE 15
Configuration of the quantizer

| | | | | | Vector lengths |
|---|---|---|---|---|---|
| | | | Quantization | | (or minimum |
| | Bit | | precision (or | | values) of |
| | representations | Quantization | a maximum | Quantization | vector |
| Indices | of indices | method | value) | types | quantization |
| 1 | 0000 | Scalar | 2 bits | Uniform | N.A. |
| | | quantization | | quantization | |
| 2 | 0001 | Vector | 3 bits | Uniform | 5 |
| | | quantization | | quantization | |
| 3 | 0010 | Vector | 5 bits | Non-uniform | 2 |
| | | quantization | | quantization | |
| 4 | 0011 | Scalar | 2 bits | Uniform | N.A. |
| | | quantization | | quantization | |
| 5 | 0100 | Vector | 7 bits | Uniform | 3 |
| | | quantization | | quantization | |
| 6 | 0101 | Vector | 7 bits | Uniform | 5 |
| | | quantization | | quantization | |
| 7 | 0111 | Scalar | 2 bits | Uniform | N.A. |
| | | quantization | | quantization | |
| 8 | 1000 | Scalar | 3 bits | Non-uniform | N.A. |
| | | quantization | | quantization | |
| 9 | 1001 | Vector | 4 bits | Non-uniform | 2 |
| | | quantization | | quantization | |
| 10 | 1010 | Vector | 5 bits | Non-uniform | 5 |
| | | quantization | | quantization | |

For yet another example, the case of joint configuration may be configuring an index in each of tables 1, 12 and 16.

TABLE 16
Configuration of the quantizer

| | | | | Vector lengths |
|---|---|---|---|---|
| | Bit | | Quantization | (or minimum |
| | represen- | | precision (or | values) of |
| | tations | Quantization | a maximum | vector |
| Indices | of indices | method | value) | quantization |
| 1 | 0000 | Scalar | 2 bits | N.A. |
| | | quantization | | |
| 2 | 0001 | Vector | 3 bits | 5 |
| | | quantization | | |
| 3 | 0010 | Vector | 5 bits | 2 |
| | | quantization | | |
| 4 | 0011 | Scalar | 2 bits | N.A. |
| | | quantization | | |
| 5 | 0100 | Vector | 7 bits | 3 |
| | | quantization | | |
| 6 | 0101 | Vector | 7 bits | 5 |
| | | quantization | | |
| 7 | 0111 | Scalar | 2 bits | N.A. |
| | | quantization | | |
| 8 | 1000 | Scalar | 3 bits | N.A. |
| | | quantization | | |
| 9 | 1001 | Vector | 4 bits | 2 |
| | | quantization | | |
| 10 | 1010 | Vector | 5 bits | 5 |
| | | quantization | | |

### Embodiment 3

In some implementations, the network device transmits first configuration information to the terminal equipment, at least a part of the first configuration information being bitwidth (e.g. a specific value) of a piece of CSI, and/or a set consisting of values of bitwidths of one or more pieces of optional CSI, and/or an allowable maximum value of a bitwidth of CSI. The at least a part of the first configuration information may also be a bitwidth of precoding matrix information (e.g. a specific value), and/or a set consisting of values of bitwidths of one or more pieces of optional precoding matrix information, and/or an allowable maximum value of a bitwidth of precoding matrix information.

In some implementations, the method for configuring the first configuration information by the network device is adding a field to the CSI reporting configuration, which is adding a field to a CSI-ReportConfig information element. For example, a field “a bitwidth of CSI (or a bitwidth of precoding matrix information)” may be added to indicate a bitwidth of a piece of CSI or a bitwidth (a specific value) of precoding matrix information. For example, CSI-bitwidth-ai is added to the CSI-ReportConfig information element, which may also be in other names. Revisions of the CSI-ReportConfig information element are as shown in Table 17.

TABLE 17
-- ASN1START
-- TAG-CSI-REPORTCONFIG-START

| CSI-ReportConfig ::= | SEQUENCE { | | | | |
|---|---|---|---|---|---|
| reportConfigID | | CSI-ReportConfigId, | | | |
| carrier | | | ServCellIndex | | OPTINAL, --Need S |
| ..., | | | | | |
| csi-bitwidth-ai | | CSI-Bitwidth-ai | | OPTIONAL, -- Need R/S/M | |
| } | | | | | |

-- TAG-CSI-REPORTCONFIG-STOP

-- ASN1STOP

As shown in Table 17, the field “a bitwidth of CSI” is added.

In various embodiments of this disclosure, “Need R/S/M” represents Need R or Need S or Need M.

In some implementations, the method for configuring the first configuration information by the network device is adding a field to the CSI reporting configuration, which is adding a field to a CSI-ReportConfig information element. For example, a field “values of bitwidths of one or more pieces of optional CSI (or values of bitwidths of one or more pieces of optional precoding matrix information)” may be added to indicate values of bitwidths of one or more pieces of optional CSI (or values of bitwidths of one or more pieces of optional precoding matrix information). For example, CSI-possible-bitwidths-ai is added to the CSI-ReportConfig information element, which may also be in other names. Revisions of the CSI-ReportConfig information element are as shown in Table 18.

TABLE 18
-- ASN1START
-- TAG-CSI-REPORTCONFIG-START

| CSI-ReportConfig ::= | SEQUENCE { | | | | |
|---|---|---|---|---|---|
| reportConfigID | | CSI-ReportConfigId, | | | |
| carrier | | | ServCellIndex | | OPTINAL, --Need S |
| ..., | | | | | |
| csi-possible-bitwidth-ai | | CSI-Possible-Bitwidth-ai | | OPTIONAL, -- Need R/S/M | |
| } | | | | | |

-- TAG-CSI-REPORTCONFIG-STOP

-- ASN1STOP

-- TAG-CSI-REPORTCONFIG-STOP

-- ASN1STOP

The field “values of bitwidths of one or more pieces of optional CSI (or values of bitwidths of one or more pieces of optional precoding matrix information)” is added in Table 18.

In some implementations, the method for configuring the first configuration information by the network device is adding a field to the CSI reporting configuration, which is adding a field to a CSI-ReportConfig information element. For example, a field “an allowable maximum value of a bitwidth of CSI (or an allowable maximum value of a bitwidth of precoding matrix information)” may be added to indicate an allowable maximum value of a bitwidth of a piece of CSI or an allowable maximum value of a bitwidth of precoding matrix information. For example, CSI-max-bitwidth-ai is added to the CSI-ReportConfig information element, which may also be in other names. Revisions of the CSI-ReportConfig information element are as shown in Table 19.

TABLE 19
-- ASN1START
-- TAG-CSI-REPORTCONFIG-START

| CSI-ReportConfig ::= | SEQUENCE { | | | | |
|---|---|---|---|---|---|
| reportConfigID | | CSI-ReportConfigId, | | | |
| carrier | | | ServCellIndex | | OPTINAL, --Need S |
| ..., | | | | | |
| csi-max-bitwidth-ai | | CSI-MaxBitwidth-ai | | OPTIONAL, -- Need R/S/M | |
| } | | | | | |

-- TAG-CSI-REPORTCONFIG-STOP

-- ASN1STOP

The field “an allowable maximum value of a bitwidth of CSI (or an allowable maximum value of a bitwidth of precoding matrix information)” is added in Table 19.

### Embodiment 4

In some implementations, the network device transmits the first configuration information to the terminal equipment, at least a part of the first configuration information being information on one or more (AI/ML-based) CSI generation models. The first configuration information further includes the limitation (or the maximum value) of the spatial layer of the CSI feedback performed based on the AI/ML method. The information on the CSI generation models gives a bitwidth of a bit sequence output thereby. Maximum values of bitwidths of bit sequences output by all the CSI generation models and the limitation (or the maximum value) of the spatial layer of the CSI feedback performed based on the AI/ML method give the allowable maximum value of the bitwidth of CSI and/or the allowable maximum value of the bitwidth of the precoding matrix information.

In some implementations, when the CSI generation models have scalability to the bitwidths of the bit sequences output thereby, a bitwidth of a maximum bit sequence output thereby is referred to as a bitwidth of a bit sequence of a CSI generation model having scalability to the bitwidths of the bit sequences output thereby. Method(s) for determining the allowable maximum value of the bitwidth of the CSI and/or the allowable maximum value of the bitwidth of the precoding matrix information is/are identical to that/those described above.

According to the embodiments of the first aspect, the first configuration information transmitted by the network device to the terminal equipment contains relevant information of bitwidths of CSI, hence, relevant information of bitwidths of CSI may be configured for the terminal equipment.

### Embodiments of a Second Aspect

The embodiments of the second aspect provide a method for receiving channel state information, applicable to a network device, such as the network device 201 in FIG. 2.

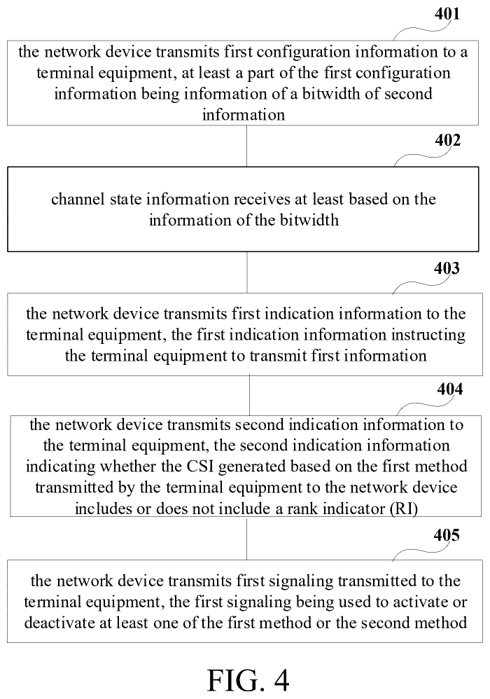

FIG. 4 is a schematic diagram of the method for receiving channel state information (CSI) of an embodiments of a second aspect of this disclosure. As shown in FIG. 4, the method includes:
401: the network device transmits first configuration information to a terminal equipment, at least a part of the first configuration information being information of a bitwidth of second information; and
402: channel state information is received at least based on the information of the bitwidth.

In at least one embodiment, the second information includes channel state information (CSI) and/or precoding matrix information.

In at least one embodiment, the information of a bitwidth of the second information includes:
a bitwidth of the second information, and/or two or more candidate values of the bitwidth of the second information, and/or a maximum value of the bitwidth of the second information, and/or a parameter and/or configuration that is/are able to calculate the maximum value of the bitwidth of the second information, wherein the parameter and/or configuration include(s) information on a model used for generating the channel state information and/or information on a second method.

In at least one embodiment, the first configuration information includes configuration information generating the CSI based on the first method and/or configuration information generating the CSI based on a second method, wherein at least one of the first method or the second method is activated.

In at least one embodiment, at least a part of the first method is a method based on an artificial intelligence model; and/or the second method is a method obtained by a codebook specified in the 3GPP standardization or obtained by revising a value range of at least one parameter of a codebook specified in the 3GPP standardization.

In at least one embodiment, the maximum value of the supported downlink transmission layers to which the first method corresponds is identical to or different from the maximum value of the supported downlink transmission layers to which the second method corresponds.

In at least one embodiment, the maximum value of the supported downlink transmission layers to which the first method corresponds is predetermined or is configured by the network device.

In at least one embodiment, as shown in FIG. 4, the method further includes:
403: the network device transmits first indication information to the terminal equipment, the first indication information indicating the terminal equipment to transmit first information, at least a part of the first information being:
a bitwidth of precoding matrix information generating CSI based on the first method and/or a bitwidth of respective precoding vector information of all transmission layers of more than one downlink transmission layer.

In at least one embodiment, as shown in FIG. 4, the method further includes:
404: the network device transmits second indication information to the terminal equipment, the second indication information indicating whether the CSI generated based on the first method transmitted by the terminal equipment to the network device includes or does not include a rank indicator (RI).

In at least one embodiment, the method further includes:
405: the network device transmits first signaling transmitted to the terminal equipment, the first signaling being used to activate or deactivate at least one of the first method or the second method.

In at least one embodiment, the first signaling includes at least one field, the field including at least one bit to activate or deactivate at least one of the first method or the second method.

In at least one embodiment, the information on the model includes information on an artificial intelligence model and/or information on a quantizer, the information on an artificial intelligence model including: the number or a maximum value of first elements output by the artificial intelligence model, and/or a type of the first elements,
wherein an output of the artificial intelligence model is an input of the quantizer.

The information on a quantizer includes: a quantization method, and/or a quantization type, and/or a quantization precision.

In at least one embodiment, at least a part of the information on the artificial intelligence model and at least a part of the information on the quantizer are configured in a combined manner; and/or
at least a part of the information on the artificial intelligence model and at least a part of the information on the quantizer are configured independently of each other.

In at least one embodiment, the first configuration information includes information on one or more models used in generating channel state information based on the first method, and/or a maximum value of the number of supported downlink transmission layers generating CSI based on the first method.

In at least one embodiment, the first configuration information includes a first field, the first field being used to indicate a value of the bitwidth of the second information; and/or
the first configuration information includes a second field, the second field being used to indicate two or more candidate values of the bitwidth of the second information; and/or
the first configuration information includes a third field, the third field being used to indicate the maximum value of the bitwidth of the second information.

### Embodiments of a Third Aspect

The embodiments of the third aspect provide an apparatus for transmitting channel state information, applicable to a terminal equipment, such as the terminal equipment 202 in FIG. 2. This apparatus corresponds to the method in the embodiments of the first aspect.

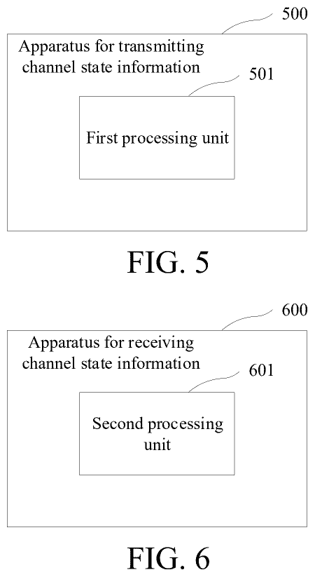

FIG. 5 is a schematic diagram of an apparatus for transmitting channel state information (CSI) of the embodiments of the third aspect. As shown in FIG. 5, an apparatus 500 includes a first processing unit 501, the first processing unit 501 controlling the terminal equipment to make the terminal equipment execute the following operations:
receiving, by the terminal equipment, first configuration information transmitted by a network device, at least a part of the first configuration information being information of a bitwidth of second information; and
transmitting channel state information at least based on the information of the bitwidth.

In at least one embodiment, the second information includes channel state information (CSI) and/or precoding matrix information.

In at least one embodiment, the information of a bitwidth of second information includes:
a bitwidth of the second information, and/or two or more candidate values of the bitwidth of the second information, and/or a maximum value of the bitwidth of the second information, and/or a parameter and/or configuration that is/are able to calculate the maximum value of the bitwidth of the second information.

In at least one embodiment, the parameter and/or configuration include(s) information on a model used for generating the channel state information and/or information on a second method.

In at least one embodiment, the first configuration information includes configuration information generating the CSI based on the first method and/or configuration information generating the CSI based on a second method, wherein at least one of the first method or the second method is activated.

In at least one embodiment, at least a part of the first method is an apparatus based on an artificial intelligence model; and/or
the second method is an apparatus obtained by a codebook specified in the 3GPP standardization or obtained by revising a value range of at least one parameter of a codebook specified in the 3GPP standardization.

In at least one embodiment, the first processing unit further controls the terminal equipment to execute the following operations:
obtaining the information of a bitwidth of second information generating CSI based on the first method by the terminal equipment according to the configuration information generating CSI based on the second method.

In at least one embodiment, the terminal equipment obtains a maximum value of a bitwidth of second information generating CSI based on the first method according to the configuration information generating CSI based on the second method and a maximum value of the number of supported downlink transmission layers.

In at least one embodiment, the maximum value of the supported downlink transmission layers to which the first method corresponds is identical to or different from the maximum value of the supported downlink transmission layers to which the second method corresponds.

In at least one embodiment, the maximum value of the supported downlink transmission layers to which the first method corresponds is predetermined or is configured by the network device.

In at least one embodiment, the first processing unit further controls the terminal equipment to execute the following operations:
receiving, by the terminal equipment, first indication information transmitted by the network device, the first indication information indicating the terminal equipment to transmit first information, at least a part of the first information being:
a bitwidth of precoding matrix information generating CSI based on the first method and/or a bitwidth of respective precoding vector information of all transmission layers of more than one downlink transmission layer.

In at least one embodiment, the first processing unit further controls the terminal equipment to execute the following operations:
receiving, by the terminal equipment, second indication information transmitted by the network device, the second indication information indicating whether the CSI generated based on the first method transmitted by the terminal equipment to the network device includes or does not include a rank indicator (RI).

In at least one embodiment, the first processing unit further controls the terminal equipment to execute the following operations:
receiving, by the terminal equipment, first signaling transmitted by the network device, the first signaling being used to activate or deactivate at least one of the first method or the second method.

In at least one embodiment, the first signaling includes at least one field, the field including at least one bit to activate or deactivate at least one of the first method or the second method.

In at least one embodiment, the terminal equipment obtains the information of a bitwidth of second information generating CSI based on the first method according to the information on a model.

In at least one embodiment, the information on the model includes information on an artificial intelligence model and/or information on a quantizer,
the information on the artificial intelligence model including: the number or a maximum value of first elements output by the artificial intelligence model, and/or a type of the first elements,
wherein an output of the artificial intelligence model is an input of the quantizer.

The information on a quantizer includes: a quantization device, and/or a quantization type, and/or a quantization precision.

In at least one embodiment, at least a part of the information on the artificial intelligence model and at least a part of the information on the quantizer are configured in a combined manner; and/or
at least a part of the information on the artificial intelligence model and at least a part of the information on the quantizer are configured independently of each other.

In at least one embodiment, the first configuration information includes information on one or more models generating channel state information based on the first method, and/or the maximum value of the number of supported downlink transmission layers generating CSI based on the first method. The terminal equipment determines a maximum value of bitwidths of bit sequences output by the one or more models according to the information on the one or more models, and obtains the information on the bitwidth of the second information generating CSI based on the first method according to the maximum value of bitwidths of bit sequences output by the one or more models and the maximum value of the number of supported downlink transmission layers generating CSI based on the first method.

In at least one embodiment, when the model has scalability to a bitwidth of a bit sequence output thereby,
a bitwidth of a maximum bit sequence output thereby is taken as a bitwidth of a bit sequence of the model having scalability to the bitwidth of the bit sequence output thereby.

In at least one embodiment, the first configuration information includes a first field, the first field being used to indicate a value of the bitwidth of the second information; and/or
the first configuration information includes a second field, the second field being used to indicate two or more candidate values of the bitwidth of the second information; and/or
the first configuration information includes a third field, the third field being used to indicate the maximum value of the bitwidth of the second information.

### Embodiments of a Fourth Aspect

The embodiments of the second aspect provide an apparatus for receiving channel state information, applicable to a network device, such as the network device 201 in FIG. 2. This apparatus corresponds to the method in the embodiments of the second aspect.

FIG. 6 is a schematic diagram of an apparatus for receiving channel state information (CSI) of the embodiments of the third aspect. As shown in FIG. 6, an apparatus 600 includes a second processing unit 601, the second processing unit 601 controlling the network device to make the network device execute the following operations:
transmitting first configuration information by the network device to a terminal equipment, at least a part of the first configuration information being information of a bitwidth of second information; and
receiving channel state information at least based on the information of the bitwidth.

In at least one embodiment, the second information includes channel state information (CSI) and/or precoding matrix information.

In at least one embodiment, the information of a bitwidth of second information includes:
a bitwidth of the second information, and/or two or more candidate values of the bitwidth of the second information, and/or a maximum value of the bitwidth of the second information, and/or a parameter and/or configuration that is/are able to calculate the maximum value of the bitwidth of the second information.

In at least one embodiment, the parameter and/or configuration include(s) information on a model used for generating the channel state information and/or information on a second method.

In at least one embodiment, the first configuration information includes configuration information generating the CSI based on the first method and/or configuration information generating the CSI based on a second method, wherein at least one of the first method or the second method is activated.

In at least one embodiment, at least a part of the first method is a device based on an artificial intelligence model; and/or
the second method is a method obtained by a codebook specified in the 3GPP standardization or obtained by revising a value range of at least one parameter of a codebook specified in the 3GPP standardization.

In at least one embodiment, the maximum value of the supported downlink transmission layers to which the first method corresponds is identical to or different from the maximum value of the supported downlink transmission layers to which the second method corresponds.

In at least one embodiment, the maximum value of the supported downlink transmission layers to which the first method corresponds is predetermined or is configured by the network device.

In at least one embodiment, the second processing unit further controls the network device to execute the following operations:
transmitting first indication information by the network device to the terminal equipment, the first indication information indicating the terminal equipment to transmit first information, at least a part of the first information being:
a bitwidth of precoding matrix information generating CSI based on the first method and/or a bitwidth of respective precoding vector information of all transmission layers of more than one downlink transmission layer.

In at least one embodiment, the second processing unit further controls the network device to execute the following operations:
transmitting second indication information by the network device to the terminal equipment, the second indication information indicating whether the CSI generated based on the first method transmitted by the terminal equipment to the network device includes or does not include a rank indicator (RI).

In at least one embodiment, the second processing unit further controls the network device to execute the following operations:
transmitting first signaling transmitted by the network device to the terminal equipment, the first signaling being used to activate or deactivate at least one of the first method or the second method.

In at least one embodiment, the first signaling includes at least one field, the field including at least one bit to activate or deactivate at least one of the first method or the second method.

In at least one embodiment, the information on the model includes information on an artificial intelligence model and/or information on a quantizer,
the information on an artificial intelligence model including: the number or a maximum value of first elements output by the artificial intelligence model, and/or a type of the first elements,
wherein an output of the artificial intelligence model is an input of the quantizer,
and the information on a quantizer includes: a quantization method, and/or a quantization type, and/or a quantization precision.

In at least one embodiment, at least a part of the information on the artificial intelligence model and at least a part of the information on the quantizer are configured in a combined manner; and/or
at least a part of the information on the artificial intelligence model and at least a part of the information on the quantizer are configured independently of each other.

In at least one embodiment, the first configuration information includes information on one or more models used in generating channel state information based on the first method, and/or a maximum value of the number of supported downlink transmission layers generating CSI based on the first method.

In at least one embodiment, the first configuration information includes a first field, the first field being used to indicate a value of the bitwidth of the second information; and/or
the first configuration information includes a second field, the second field being used to indicate two or more candidate values of the bitwidth of the second information; and/or
the first configuration information includes a third field, the third field being used to indicate the maximum value of the bitwidth of the second information.

### Embodiments of a Fifth Aspect

The embodiments of the fifth aspect of this disclosure provide a communication system, including a network device and a terminal equipment.

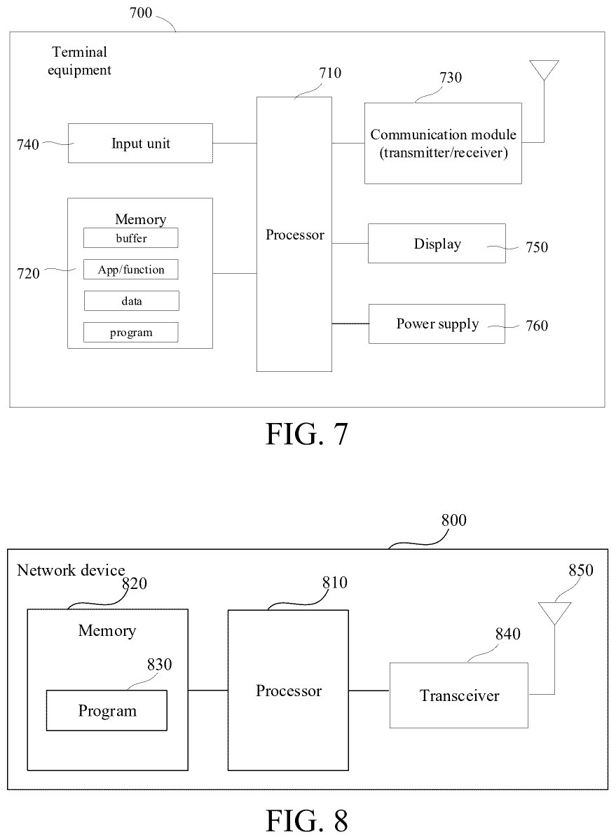

FIG. 7 is a schematic diagram of a terminal equipment of the embodiments of the fifth aspect of this disclosure. As shown in FIG. 7, a terminal equipment 700 (such as corresponding to the terminal equipment 202 in FIG. 2) may include a processor 710 and a memory 720, the memory 720 storing data and a program and being coupled to the processor 710. It should be noted that this figure is illustrative only, and other types of structures may also be used, so as to supplement or replace this structure and achieve a telecommunications function or other functions.

For example, the processor 710 may be configured to execute a program to carry out the method described in the embodiments of the first aspect.

As shown in FIG. 7, the terminal equipment 700 may further include a communication module 730, an input unit 740, a display 750, and a power supply 760; wherein functions of the above components are similar to those in the related art, which shall not be described herein any further. It should be noted that the terminal equipment 700 does not necessarily include all the parts shown in FIG. 7, and the above components are not necessary. Furthermore, the terminal equipment 700 may include parts not shown in FIG. 7, and the related art may be referred to.

FIG. 8 is a schematic diagram of a network device of the embodiments of the fifth aspect. As shown in FIG. 8, a network device 800 (such as corresponding to the network device 201 in FIG. 2) may include a processor 810 (such as a central processing unit (CPU) and a memory 820, the memory 820 being coupled to the processor 810. Wherein, the memory 820 may store various data, and furthermore, it may store a program 830 for information processing, and execute the program under control of the processor 810.

For example, the processor 810 may be configured to execute a program to carry out the method described in the embodiments of the second aspect.

Furthermore, as shown in FIG. 8, the network device 800 may include a transceiver 840, and an antenna 850, etc. Functions of the above components are similar to those in the related art, and shall not be described herein any further. It should be noted that the network device 800 does not necessarily include all the parts shown in FIG. 8, and furthermore, the network device 800 may include parts not shown in FIG. 8, and the related art may be referred to.

Embodiments of this disclosure provide a computer readable program, which, when executed in a terminal equipment, causes the terminal equipment to carry out the method as described in the embodiments of the first aspect.

Embodiments of this disclosure provide a computer storage medium, including a computer readable program, which causes a terminal equipment to carry out the method as described in the embodiments of the first aspect.

Embodiments of this disclosure provide a computer readable program, which, when executed in a network device, causes the network device to carry out the method as described in the embodiments of the second aspect.

Embodiments of this disclosure provide a computer storage medium, including a computer readable program, which causes a network device to carry out the method as described in the embodiments of the second aspect.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, an EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principle of the present disclosure, and such variants and modifications fall within the scope of the present disclosure.

As to implementations containing the above embodiments, following supplements are further disclosed.

A method of a terminal equipment:
1. A method for transmitting channel state information (CSI), applicable to a terminal equipment, the method including:
receiving, by the terminal equipment, first configuration information transmitted by a network device, at least a part of the first configuration information being information of a bitwidth of second information; and
transmitting channel state information at least based on the information of the bitwidth.
2. The method according to supplement 1, wherein, the second information includes channel state information (CSI) and/or precoding matrix information.
3. The method according to supplement 1, wherein,
the information of a bitwidth of second information may include:
a bitwidth of the second information, and/or two or more candidate values of the bitwidth of the second information, and/or a maximum value of the bitwidth of the second information, and/or a parameter and/or configuration that is/are able to calculate the maximum value of the bitwidth of the second information.
4. The method according to supplement 3, wherein,
the parameter and/or configuration include(s) information on a model used for generating the channel state information and/or information on a second method.
5. The method according to supplement 4, wherein,
the first configuration information includes configuration information generating the CSI based on the first method and/or configuration information generating the CSI based on a second method, wherein at least one of the first method or the second method is activated.
6. The method according to supplement 5, wherein,
at least a part of the first method is a method based on an artificial intelligence model, and/or
the second method is a method obtained by a codebook specified in the 3GPP standardization or obtained by revising a value range of at least one parameter of a codebook specified in the 3GPP standardization.
7. The method according to supplement 5, wherein the method further includes:
obtaining the information of a bitwidth of second information generating CSI based on the first method by the terminal equipment according to the configuration information generating CSI based on the second method.
8. The method according to supplement 7, wherein,
the terminal equipment obtains the maximum value of the bitwidth of the second information generating CSI based on the first method according to the configuration information generating CSI based on the second method and a maximum value of the number of supported downlink transmission layers.
9. The method according to supplement 8, wherein,
the maximum value of the supported downlink transmission layers to which the first method corresponds is identical to or different from the maximum value of the supported downlink transmission layers to which the second method corresponds.
10. The method according to supplement 8, wherein,
the maximum value of the supported downlink transmission layers to which the first method corresponds is predetermined or is configured by the network device.
11. The method according to supplement 5, wherein the method further includes:
receiving, by the terminal equipment, first indication information transmitted by the network device, the first indication information indicating that the terminal equipment transmits first information, at least a part of the first information being:
a bitwidth of precoding matrix information generating CSI based on the first method and/or a bitwidth of respective precoding vector information of all transmission layers of more than one downlink transmission layer.
12. The method according to supplement 5, wherein the method further includes:
receiving, by the terminal equipment, second indication information transmitted by the network device, the second indication information indicating whether the CSI generated based on the first method transmitted by the terminal equipment to the network device includes or does not include a rank indicator (RI).
13. The method according to supplement 5, wherein the method further includes:
receiving, by the terminal equipment, first signaling transmitted by the network device, the first signaling being used to activate or deactivate at least one of the first method or the second method.
14. The method according to supplement 13, wherein,
the first signaling includes at least one field, the field including at least one bit to activate or deactivate at least one of the first method or the second method.
15. The method according to supplement 4, wherein,
the terminal equipment obtains the information on the bitwidth of the second information generating CSI based on the first method according to the information on the model.
16. The method according to supplement 15, wherein,
the information on the model includes information on an artificial intelligence model and/or information on a quantizer,
the information on the artificial intelligence model including: the number or a maximum value of first elements output by the artificial intelligence model, and/or a type of the first elements,
wherein an output of the artificial intelligence model is an input of the quantizer,
and the information on a quantizer includes: a quantization method, and/or a quantization type, and/or a quantization precision.
17. The method according to supplement 16, wherein,
at least a part of the information on the artificial intelligence model and at least a part of the information on the quantizer are configured in a combined manner; and/or
at least a part of the information on the artificial intelligence model and at least a part of the information on the quantizer are configured independently of each other.
18. The method according to supplement 3, wherein,
the first configuration information includes information on one or more models generating channel state information based on the first method, and/or the maximum value of the number of supported downlink transmission layers generating CSI based on the first method,
the terminal equipment determines a maximum value of bitwidths of bit sequences output by the one or more models according to the information on the one or more models,
and the terminal equipment obtains the information on the bitwidth of the second information generating CSI based on the first method according to the maximum value of bitwidths of bit sequences output by the one or more models and the maximum value of the number of supported downlink transmission layers generating CSI based on the first method.
19. The method according to supplement 18, wherein,
when the model has a scalability for the bitwidth of the output bit sequence,
a maximum bitwidth of one or more output bit sequences of the model is taken as a bitwidth of an output bit sequence of the model having a scalability for the bitwidth of the output bit sequence.
20. The method according to supplement 3, wherein,
the first configuration information includes a first field, the first field being used to indicate a value of the bitwidth of the second information; and/or
the first configuration information includes a second field, the second field being used to indicate two or more candidate values of the bitwidth of the second information; and/or
the first configuration information includes a third field, the third field being used to indicate the maximum value of the bitwidth of the second information.

A method at a network device side:
1. A method for receiving channel state information (CSI), applicable to a network device, the method including:
transmitting first configuration information by the network device to a terminal equipment, at least a part of the first configuration information being information of a bitwidth of second information; and
receiving channel state information at least based on the information of the bitwidth.
2. The method according to supplement 1, wherein,
the second information includes channel state information (CSI) and/or precoding matrix information.
3. The method according to supplement 1, wherein,
the information of a bitwidth of second information includes:
a bitwidth of the second information, and/or two or more candidate values of the bitwidth of the second information, and/or a maximum value of the bitwidth of the second information, and/or a parameter and/or configuration that is/are able to calculate the maximum value of the bitwidth of the second information.
4. The method according to supplement 3, wherein,
the parameter and/or configuration include(s) information on a model used for generating the channel state information and/or information on a second method.
5. The method according to supplement 4, wherein,
the first configuration information includes configuration information generating the CSI based on the first method and/or configuration information generating the CSI based on a second method,
wherein at least one of the first method or the second method is activated.
6. The method according to supplement 5, wherein,
at least a part of the first method is a method based on an artificial intelligence model; and/or
the second method is a method obtained by a codebook specified in the 3GPP standardization or obtained by revising a value range of at least one parameter of a codebook specified in the 3GPP standardization.
7. The method according to supplement 5, wherein,
the maximum value of the supported downlink transmission layers to which the first method corresponds is identical to or different from the maximum value of the supported downlink transmission layers to which the second method corresponds.
8. The method according to supplement 5, wherein,
the maximum value of the supported downlink transmission layers to which the first method corresponds is predetermined or is configured by the network device.
9. The method according to supplement 5, wherein the method further includes:
transmitting first indication information by the network device to the terminal equipment, the first indication information indicating the terminal equipment to transmit first information, at least a part of the first information being:
a bitwidth of precoding matrix information generating CSI based on the first method and/or a bitwidth of respective precoding vector information of all transmission layers of more than one downlink transmission layer.
10. The method according to supplement 5, wherein the method further includes:
transmitting second indication information by the network device to the terminal equipment, the second indication information indicating whether the CSI generated based on the first method transmitted by the terminal equipment to the network device includes or does not include a rank indicator (RI).
11. The method according to supplement 5, wherein the method further includes:
transmitting first signaling transmitted by the network device to the terminal equipment, the first signaling being used to activate or deactivate at least one of the first method or the second method.
12. The method according to supplement 11, wherein,
the first signaling includes at least one field, the field including at least one bit to activate or deactivate at least one of the first method or the second method.
13. The method according to supplement 4, wherein,
the information on the model includes information on an artificial intelligence model and/or information on a quantizer,
the information on an artificial intelligence model including: the number or a maximum value of first elements output by the artificial intelligence model, and/or a type of the first elements,
wherein an output of the artificial intelligence model is an input of the quantizer,
and the information on a quantizer includes: a quantization method, and/or a quantization type, and/or a quantization precision.
14. The method according to supplement 13, wherein,
at least a part of the information on the artificial intelligence model and at least a part of the information on the quantizer are configured in a combined manner; and/or
at least a part of the information on the artificial intelligence model and at least a part of the information on the quantizer are configured independently of each other.
15. The method according to supplement 3, wherein,
the first configuration information includes information on one or more models used in generating channel state information based on the first method, and/or a maximum value of the number of supported downlink transmission layers generating CSI based on the first method.
16. The method according to supplement 3, wherein,
the first configuration information includes a first field, the first field being used to indicate a value of the bitwidth of the second information; and/or
the first configuration information includes a second field, the second field being used to indicate two or more candidate values of the bitwidth of the second information; and/or
the first configuration information includes a third field, the third field being used to indicate the maximum value of the bitwidth of the second information.

What is claimed is:

1. An apparatus for transmitting channel state information, applicable to a terminal equipment, the apparatus comprising first processor circuitry,
wherein the terminal equipment, by the first processor circuitry controlling the terminal equipment, is configured to:
receive, by the terminal equipment, first configuration information transmitted by a network device, at least a part of the first configuration information being information of a bitwidth of second information; and
transmit channel state information at least based on the information of the bitwidth.

2. The apparatus according to claim 1, wherein,
the second information comprises channel state information (CSI) and/or precoding matrix information.

3. The apparatus according to claim 1, wherein,
the information of a bitwidth of second information comprises:
a bitwidth of the second information, and/or two or more candidate values of the bitwidth of the second information, and/or a maximum value of the bitwidth of the second information, and/or a parameter and/or configuration that is/are able to calculate a maximum value of the bitwidth of the second information.

4. The apparatus according to claim 3, wherein,
the parameter and/or configuration comprise(s) information on a model used for generating the channel state information and/or information on a second method.

5. The apparatus according to claim 4, wherein,
the first configuration information comprises configuration information generating the CSI based on a first method and/or configuration information generating the CSI based on the second method,
wherein at least one of the first method or the second method is activated.

6. The apparatus according to claim 5, wherein,
at least a part of the first method is a method based on an artificial intelligence model; and/or
the second method is a method obtained by a codebook specified in the 3GPP standardization or obtained by revising a value range of at least one parameter of a codebook specified in the 3GPP standardization.

7. The apparatus according to claim 5, wherein the terminal equipment, by the first processor circuitry, is configured to:
obtain information of a bitwidth of second information generating CSI based on the first method by the terminal equipment according to the configuration information generating CSI based on the second method.

8. The apparatus according to claim 7, wherein,
the terminal equipment obtains a maximum value of a bitwidth of second information generating CSI based on the first method according to the configuration information generating CSI based on the second method and a maximum value of the number of supported downlink transmission layers.

9. The apparatus according to claim 4, wherein,
the terminal equipment obtains information of a bitwidth of second information generating CSI based on a first method according to the information on the model.

10. The apparatus according to claim 3, wherein,
the first configuration information includes a first field, the first field being used to indicate a value of the bitwidth of the second information; and/or
the first configuration information includes a second field, the second field being used to indicate the two or more candidate values of the bitwidth of the second information; and/or
the first configuration information includes a third field, the third field being used to indicate the maximum value of the bitwidth of the second information.

11. An apparatus for receiving channel state information, applicable to a network device, the apparatus comprising second processor circuitry,
wherein the network device, by the second processor circuitry controlling the network device, is configured to:
transmit first configuration information by the network device to a terminal equipment, at least a part of the first configuration information being information of a bitwidth of second information; and
receive channel state information at least based on the information of the bitwidth.

12. The apparatus according to claim 11, wherein,
the second information comprises channel state information (CSI) and/or precoding matrix information.

13. The apparatus according to claim 11, wherein,
the information of a bitwidth of second information comprises:
a bitwidth of the second information, and/or two or more candidate values of the bitwidth of the second information, and/or a maximum value of the bitwidth of the second information, and/or a parameter and/or configuration that is/are able to calculate the maximum value of the bitwidth of the second information.

14. The apparatus according to claim 13, wherein,
the parameter and/or configuration comprise(s) information on a model used for generating the channel state information and/or information on a second method.

15. The apparatus according to claim 14, wherein,
the first configuration information comprises configuration information generating the CSI based on a first method and/or configuration information generating the CSI based on the second method,
wherein at least one of the first method or the second method is activated.

16. The apparatus according to claim 15, wherein,
at least a part of the first method is a method based on an artificial intelligence model; and/or
the second method is a method obtained by a codebook specified in the 3GPP standardization or obtained by revising a value range of at least one parameter of a codebook specified in the 3GPP standardization.

17. The apparatus according to claim 15, wherein the network device, by the second processor circuitry, is configured to:
transmit first indication information by the network device to the terminal equipment, the first indication information indicating the terminal equipment to transmit first information, at least a part of the first information being:
a bitwidth of precoding matrix information generating CSI based on the first method and/or a bitwidth of respective precoding vector information of all transmission layers of more than one downlink transmission layer.

18. The apparatus according to claim 14, wherein,
the information on the model comprises information on an artificial intelligence model and/or information on a quantizer,
the information on an artificial intelligence model comprising: the number or a maximum value of first elements output by the artificial intelligence model, and/or a type of the first elements,
wherein an output of the artificial intelligence model is an input of the quantizer,
and the information on a quantizer comprising: a quantization method, and/or a quantization type, and/or a quantization precision.

19. The apparatus according to claim 13, wherein,
the first configuration information comprises information on one or more models used in generating channel state information based on a first method, and/or a maximum value of the number of supported downlink transmission layers generating CSI based on a first method.

20. The apparatus according to claim 13, wherein,
the first configuration information includes a first field, the first field being used to indicate a value of the bitwidth of the second information; and/or
the first configuration information includes a second field, the second field being used to indicate two or more candidate values of the bitwidth of the second information; and/or
the first configuration information includes a third field, the third field being used to indicate the maximum value of the bitwidth of the second information.
